(19) United States
(12) Patent Application Publication
(10) Pub. No.: US 2017/0146370 A1
(43) Pub. Date: May 25, 2017

(54) Method for determining an orthogonality error between two sensor signals

(71) Applicant: CONTINENTAL AUTOMOTIVE GMBH, Hannover (DE)

(72) Inventor: Jens Gleissberg, Schwalbach a.Ts. (DE)

(73) Assignee: CONTINENTAL AUTOMOTIVE GMBH, Hannover (DE)

(21) Appl. No.: 15/427,508

(22) Filed: Feb. 8, 2017

Related U.S. Application Data
(63) Continuation of application No. PCT/EP2015/068710, filed on Aug. 13, 2015.

(30) Foreign Application Priority Data
Aug. 14, 2014 (DE) 10 2014 216 224.6

(51) Int. Cl. G01D 5/244

(52) U.S. Cl. CPC G01D 5/24476

(57) ABSTRACT

A method for determining an error between two sensor signals in an angle sensor which, based on an angle transmitter, outputs the sensor signals. The sensor signals have a periodic profile and are mathematically in an orthogonal relationship with one another. A deviation from the orthogonal relationship between the sensor signals can occur because of the error. The method includes forming a radius signal using the sums of squares of the sensor signals, and determining the second harmonic of the radius signal, where n is equal to a positive integer. The method also includes determining the error of a value of the amplitude at the second harmonic, which value has been phase-shifted through 90° with respect to the rotation angle value.

### CROSS-REFERENCE TO RELATED APPLICATIONS

This application claims the benefit of PCT Application PCT/EP2015/068710, filed Aug. 13, 2015, which claims priority to German Application DE 10 2014 216 224.6, filed Aug. 14, 2014. The disclosures of the above applications are incorporated herein by reference.

### TECHNICAL FIELD

The disclosure relates to a method for determining an error between two sensor signals in an angle sensor.

### BACKGROUND

The document DE 10 2010 003 201 A1 is known from the prior art, in which a method for determining an angle of rotation with an angle measuring unit is disclosed. This document discloses how the angle of rotation can be determined with a correction value in such a way that the effect of an error or of an error angle F on the value of the angle of rotation is eradicated as far as possible. This concerns an error that results from a not entirely exact orthogonality between a sinusoidal and a cosine-formed sensor signal of the sensor element.

### SUMMARY

It is desirable to have a method for determining an error between two sensor signals in an angle sensor with which the value of the error can be determined as simply as possible. The sensor signals may be a periodic signal, for example a sine and a cosine signal, that are phase-shifted through 90° with respect to one another. Due to the orthogonal relationship between the sensor signals, the sensor signals should comply with the condition according to the addition theorem, sin² (x)+cos² (x)=1, where x is the value of the angle of rotation. The radius signal is therefore formed from the sensor signals, preferably according to sin² (x)+cos² (x), so that this magnitude can be used as an indicator for the quality of the sensor signals.

The disclosure is based on the fundamental idea that the error has a direct effect on the amplitude of the second harmonic of the radius signal, or on an integer multiple of that harmonic, and therefore an analysis of the amplitude of the second harmonic gives direct information about the magnitude of the error. In particular, the disclosure is based on the recognition that the error in the second harmonic of the radius signal occurs with a phase shift of 90° to the angle of rotation, so that the imaginary component of the harmonic yields information about the error.

The advantage of the disclosure lies in the fact that the error can be determined based on the radius signal, which can be determined solely based on the two sensor signals. Since these signals are in any case necessary in order to determine the angle of rotation, no change to existing angle of rotation sensors is needed. There is no need for a reference sensor signal with which the sensor signals could be individually compared in order to determine the error in the individual sensor signals. The method can therefore be integrated particularly easily into existing systems, since the electronic means necessary for the evaluation of the sensor signals are in any case present.

The mathematical derivation is accordingly as follows. The amplitude of the radius signal can be represented by means of the equation

e_orth(x)=sin²(x)+cos²(x+y), (1)

where x stands for the value of the angle of rotation, and y for the value of the error. Provided the error y=0, the condition of the addition theorem, referred to above, is satisfied.

The amplitude of the radius signal has a maximum, amongst others, at an angle of 45°, so that the radius signal adopts the following value at x=45°:

e_orth(45°)=1−sin(y). (2)

The value of 45° is used here by way of example. The second harmonic can also be examined at other places where it reaches a minimum or a maximum.

The error has an effect in this case on the imaginary component of the second harmonic, so that the equation

y=arc sin|e_orth,2*n.,im| (3)

can be used to determine the value of the error.

It is particularly advantageous to analyze the harmonic by means of a Fourier transform, since in this way the values of the second harmonic at the maximums or minimums are obtained directly, and in this way the analysis of the second harmonic can be carried out easily. Depending on the application, it is possible for the determination of the error to be carried out before an angle sensor is put into operation, or during ongoing operation of the angle sensor. It is helpful to select the particular form of the Fourier transform (FT) depending on this. Amongst others, the discrete FT, fast FT, or a combination of both FTs are advantageous.

The determination of the error can be carried out by means of an evaluation unit of the angle of rotation sensor or by a dedicated computing unit directly at the sensor element. The disclosure therefore also includes an angle sensor with a sensor element for detecting two sensor signals, along with a computing unit for determining the error in accordance with the method of the disclosure.

In some implementations, a method is provided for determining an error between two sensor signals in an angle sensor which, based on an angle transmitter, outputs the sensor signals. The sensor signals have a periodic profile and are mathematically in an orthogonal relationship with one another. A deviation from the orthogonal relationship between the sensor signals can occur because of the error (y). The method includes the following steps: determining an angle of rotation (x) from the sensor signals; determining a conversion value by performing a Fourier transform for the angle of rotation that has been determined; and determining the error based on the conversion value.

It is conceivable for the Fourier transform also to be carried out based on the angle of rotation calculated from the sensor signals. As a result of the orthogonality error that is present, the angle of rotation determined from the sensor signals causes an error in the result of the Fourier transform, so that a conclusion regarding the orthogonality error is possible based on this result.

The details of one or more implementations of the disclosure are set forth in the accompanying drawings and the description below. Other aspects, features, and advantages will be apparent from the description and drawings, and from the claims.

### DESCRIPTION OF DRAWINGS

The disclosure is explained in more detail with reference to figures. Here:

FIG. 1 shows an illustration of the sensor signals and of the radius signal, as well as the errors in the sensor signals.

Like reference symbols in the various drawings indicate like elements.

### DETAILED DESCRIPTION

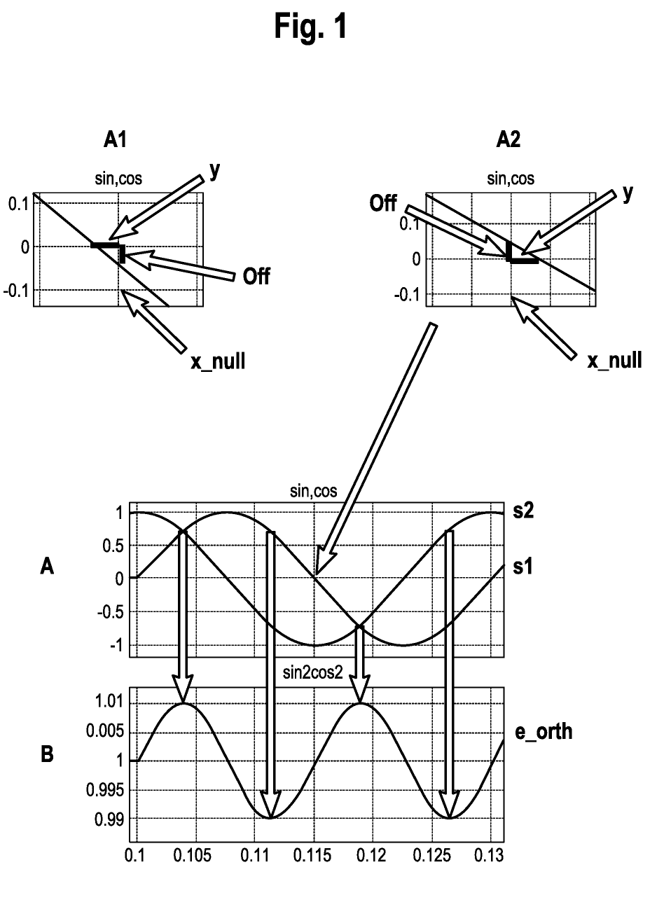

FIG. 1 shows two diagrams, where the sensor signals s1 (sine) and s2 (cosine) for one period are illustrated in a first diagram A. The radius signal e_orth is shown in a second diagram B, which is derived from the sensor signals s1, s2. Enlarged details from diagram A are respectively illustrated above diagram A. These details show the sensor signals s1, s2 in the region of the zero crossing. It can be seen here that, as a result of the orthogonality error or of the error y, the true zero crossing does not occur at the provided angle of rotation x_null, but rather before it or after it (the abscissa represents the angle of rotation). At the true zero angle of rotation x_null, the sensor signal exhibits a deviation from the zero value, which represents an offset Off.

One period of each of the sensor signals s1 and s2 is to be seen in diagram A. The radius signal that can be determined from this has two periods, and forms the second harmonic of the sensor signals s1, s2. The orthogonality of the two sensor signals has the consequence that precisely the second harmonic achieves a maximum at the crossover points of the two sensor signals s1, s2 (see diagram B), so that the magnitude of the error Y can be directly quantified based on the imaginary component of the radius signal at the maxima. The real component of the radius signal, on the other hand, represents a scaling error or an amplification error, i.e., it is a characteristic magnitude for the different amplifications of the amplitudes of the sensor signals s1 and s2.

The orthogonality error between the two sensor signals does not usually change over the service life of the angle sensor. For that reason it can be adequate to determine the error and compensate for it prior to starting use, whether in a vehicle or before completing production. It is also possible for this purpose for an external computing unit to be used, in order to read out the sensor signals s1, s2 and to determine the error. Depending on the computing power available in the evaluation electronics with which the angle sensor is operated, it can however also be advantageous to perform the determination of and the compensation for the error online, i.e. during ongoing operation.

To determine this error, the radius signal e_orth is formed from the sensor signals s1 and s2 known per se, and a harmonic analysis is carried out for this signal e_orth. For this reason, the radius signal is preferably converted by means of an FT analysis to a frequency domain, and the imaginary component of the second harmonic determined from this. The arcsine for this value is then calculated for this purpose, from which the error or the angular offset is obtained.

The following calculation is obtained by way of example for the illustrated radius signal for one period:

e_orth,2=0.02+0.0175i (4)

The imaginary component is the important component for the orthogonality error, which in this case adopts the value 0.0175. The orthogonality error is thus yielded by the equation:

y=arc sin(0.0175)=1° (5)

Depending on how many periods are considered, a 2*nth harmonic can also be involved, and is to be analyzed. For example, the 10th harmonic would be employed to determine the error if the error is calculated over five periods.

A number of implementations have been described. Nevertheless, it will be understood that various modifications may be made without departing from the spirit and scope of the disclosure. Accordingly, other implementations are within the scope of the following claims.

What is claimed is:

1. A method for determining an error between two sensor signals in an angle sensor which, based on an angle transmitter, outputs the sensor signals which have a periodic profile and are mathematically in an orthogonal relationship with one another, a deviation from the orthogonal relationship between the sensor signals can occur because of the error, the method comprising:
forming a radius signal using sums of the squares of the sensor signals;
determining a second harmonic of the radius signal, where n is equal to a positive integer; and
determining an error of a value of an amplitude at the second harmonic, which value has been phase-shifted through 90° with respect to a rotation angle value.

2. The method of claim 1, further comprising:
determining a frequency component or frequency components of the radius signal by means of a Fourier transform; and
determining the error based on an imaginary component of the frequency component or of the frequency components of the second harmonic.

3. The method of claim 2, wherein the Fourier transform is carried out by means of a fast and/or a discrete Fourier transform.

4. The method of claim 2, the error is calculated by means of equation:
y=arc sin|e_orth,2*n.,im|

where y is the error, e_orth,2.,im represents the imaginary component of the amplitude of the second harmonic of the radius signal.

5. The method of claim 1, wherein a real component of the second harmonic is used as a measure for a scaling error.

6. The method of claim 1, wherein the method is employed in the course of ongoing operation.

7. The method of claim 1, wherein the method is performed before starting the operation of an angle sensor, by means of an external computing unit.

8. A method for determining an error between two sensor signals in an angle sensor which, based on an angle transmitter, outputs the sensor signals which have a periodic profile and are mathematically in an orthogonal relationship with one another, wherein a deviation from the orthogonal relationship between the sensor signals can occur because of the error, the method comprising:
determining an angle of rotation from the sensor signals;
determining a conversion value by performing a Fourier transform for the angle of rotation that has been determined; and
determining the error based on the conversion value.

9. An angle sensor for detecting an angle of rotation, the angle sensor comprising:
a sensor element which, based on an angle encoder, outputs sensor signals having a periodic profile and are mathematically in an orthogonal relationship with one another; and
a computing unit configured to execute a method for determining an error between two sensor signals, a deviation from the orthogonal relationship between the sensor signals can occur because of the error, the method comprising:
forming a radius signal using sums of the squares of the sensor signals;
determining a second harmonic of the radius signal, where n is equal to a positive integer; and
determining an error of a value of an amplitude at the second harmonic, which value has been phase-shifted through 90° with respect to a rotation angle value.

10. An angle sensor for detecting an angle of rotation, the angle sensor comprising:
a sensor element which, based on an angle encoder, outputs sensor signals having a periodic profile and are mathematically in an orthogonal relationship with one another; and
a computing unit configured to execute a method for determining an error between two sensor signals in an angle sensor which, based on an angle transmitter, outputs the sensor signals which have a periodic profile and are mathematically in an orthogonal relationship with one another, wherein a deviation from the orthogonal relationship between the sensor signals can occur because of the error, the method comprising:
determining an angle of rotation from the sensor signals;
determining a conversion value by performing a Fourier transform for the angle of rotation that has been determined; and
determining the error based on the conversion value
